(19) United States
(12) Patent Application Publication
(10) Pub. No.: US 2013/0054170 A1
(43) Pub. Date: Feb. 28, 2013

(54) TEST SYSTEMS WITH NETWORK-BASED TEST STATION CONFIGURATION

(71) Applicants: Srdjan Sobajic, San Carlos, CA (US); Travis Gregg, San Francisco, CA (US); Tony Behen, Petaluma, CA (US); Mahmood Sheikh, Santa Clara, CA (US)

(72) Inventors: Srdjan Sobajic, San Carlos, CA (US); Travis Gregg, San Francisco, CA (US); Tony Behen, Petaluma, CA (US); Mahmood Sheikh, Santa Clara, CA (US)

(21) Appl. No.: 13/219,367

(22) Filed: Aug. 26, 2011

(51) Int. Cl. G06F 19/00

(52) U.S. Cl. 702/82

(57) ABSTRACT

A test system for testing a device under test (DUT) is provided. The test system may include multiple test stations that are coupled to a network server. A master test station configuration file associated with each of the test stations may be stored on the network server. Each of the test stations may intermittently obtain updated test station configuration information from the network server to synchronize testing. A test station may be configured to check whether the DUT has successfully passed testing at preceding test stations. The test station may be given permission to write its test results into storage circuitry in the DUT. If test results are satisfactory, the DUT may be tested using a subsequent test station. If test results do not satisfy design criteria, the DUT may be sent to a corresponding repair station for rework.

### BACKGROUND

This relates to testing, and, more particularly, to testing electronic devices during manufacturing.

Electronic devices such as portable computers, media players, cellular telephones, set-top boxes, and other electronic equipment must generally be tested during manufacturing. Tests are performed during manufacturing to ensure that devices are operating satisfactorily before they are shipped and sold to end users. For example, pass-fail tests are often performed in which a device is tested to determine whether it is operating within specified limits. If a device is not operating properly, a test operator may have that device reworked or discarded.

During testing, an electronic device that is being tested is often referred to as a device under test (i.e., a “DUT”). In a typical scenario, the device under test may be passed through a production test line having multiple test stations. At each test station, the device under test may be coupled to a different set of test equipment. For instance, a device under test can be tested using a first test station during a first time period, using a second test station during a second time period following the first time period, and using a third test station during a third time period following the second time period. Each of the first, second, and third test stations produce test results indicative of whether or not the device under test satisfies design criteria.

As an example, the first test station can determine that the device under test contains faulty wireless circuitry and generate a failed status. That device under test will still be tested by the second test station (and perhaps even by the third test station and other subsequent test stations) regardless of the failed status generated by the first test station (i.e., the second test station does not check whether the device under test has previously passed or failed).

The accuracy of test results obtained using the second test station may, however, rely on the assumption that the device under test has successfully passed at the first test station. Oftentimes, a device under test is tested at multiple test stations before the test operator realizes that the device under test is faulty and needs to be sent for repair. Testing device under test using a current test station without checking the status associated with previous test stations wastes valuable testing resources by allowing faulty devices to propagate down the test line.

Moreover, test results for a device under test that are obtained by each test station are typically stored on a network server. After testing a particular device using a series of test stations, the test operator may (at times) query the network server to retrieve the test results for that particular device. Querying information from the network server is time consuming and can reduce production line test efficiency.

It may therefore be desirable to be able to provide improved ways for testing devices under test using multiple test stations.

### SUMMARY

A test system for testing an electronic device under test (DUT) is provided. The test system may include a plurality of test stations each of which is coupled to a central network server. A master test station configuration file associated with each test station may be stored in the network server.

A DUT may be tested using a series of test stations in a production test line in a particular order. The test station at which the DUT is currently being tested may sometimes be referred to as the current test station. Test stations through which the DUT has previously undergone testing (e.g., test stations preceding the current test station in the production test line) may be referred to as previous test stations. Test stations coming after the current test station in the production test line may be referred to as subsequent test stations.

Test status information may be stored internally on storage circuitry in the DUT. For example, test status information stored on the DUT may include test status (e.g., information reflective of whether the DUT has been tested and if the DUT has passed/failed) and fail count information (e.g., information reflective of the number of times the DUT has failed) associated with each test station in the test system.

Each test station may continuously retrieve a copy of the master test station configuration file from the network server so that testing is synchronized across the entire test system. The test station configuration file may configure the current test station to check whether the DUT has passed testing at predetermined previous test stations (e.g., by checking if the test status associated with the predetermined previous test stations has a passing test status).

In response to determining that the predetermined previous passing test stations all have a passing test status, the current test station may proceed to test the DUT (e.g., to measures its radio-frequency performance, to measure its audio performance, to detect for manufacturing defects, etc.). If current test results are favorable, the current test station may be configured to clear the test status for first related test stations (e.g., to set the test statuses for the first related test stations to untested). If current test results are unsatisfactory, the current test station may be configured to clear the test status for second related test stations that are different than the first related test stations (e.g., to set the test statuses for the second related test stations to untested) and to increment the fail count for the current test station. If the fail count exceeds a predetermined threshold value, the DUT may be sent to a corresponding repair line for rework.

Further features of the present invention, its nature and various advantages will be more apparent from the accompanying drawings and the following detailed description.

### BRIEF DESCRIPTION OF THE DRAWINGS

FIG. 1 is a diagram of an electronic device being tested in an illustrative test system having multiple test stations that are coupled to a network server in accordance with an embodiment of the present invention.

FIG. 2 is a diagram of an illustrative test system having a production test line and a repair line in accordance with an embodiment of the present invention.

FIG. 3 is a diagram showing test status information that may be stored internally on a device under test in accordance with an embodiment of the present invention.

FIG. 4 is a diagram of an illustrative test station test station configuration file in accordance with an embodiment of the present invention.

FIGS. 5A and 5B are flow charts showing illustrative steps involved in testing a device under test using the test system of the type shown in FIG. 2 in accordance with an embodiment of the present invention.

### DETAILED DESCRIPTION

Embodiments of the present invention relate to testing of electronic devices. The electronic devices that are tested may include cellular telephones, computers, computer monitors with built in wireless capabilities, desktop computers, portable computers, handheld computers, laptop computers, tablet computers, media players, satellite navigation system devices, and other electronic equipment. An electric device being tested is often referred to as a device under test (DUT).

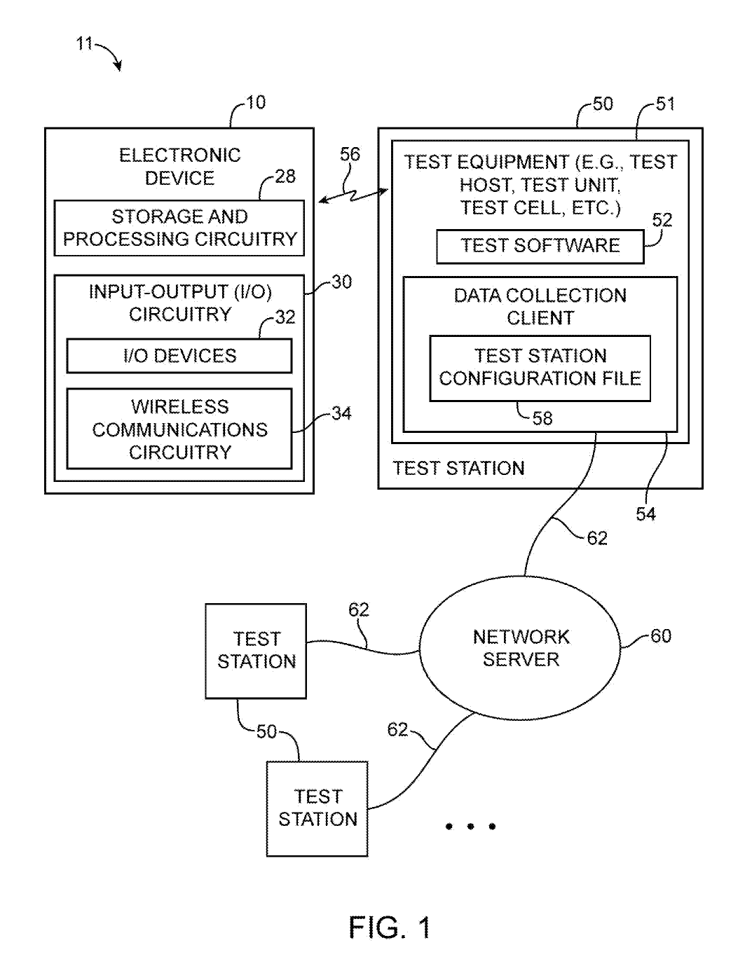

A schematic diagram of an electronic device such as device under test 10 is shown in FIG. 1. As shown in FIG. 1, device 10 may include storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. This processing circuitry may be based on one or more microprocessors, microcontrollers, digital signal processors, baseband processors, power management units, audio codec chips, application specific integrated circuits, etc.

Storage and processing circuitry 28 may be used to run software on device 10, such as internet browsing applications, voice-over-internet-protocol (VOIP) telephone call applications, email applications, media playback applications, operating system functions, etc. To support interactions with external equipment, storage and processing circuitry 28 may be used in implementing communications protocols. Communications protocols that may be implemented using storage and processing circuitry 28 include internet protocols, wireless local area network (WLAN) protocols (e.g., IEEE 802.11 protocols sometimes referred to as WiFi®), protocols for other short-range wireless communications links such as the Bluetooth® protocol, cellular telephone protocols, etc.

Circuitry 28 may be configured to implement control algorithms that control the use of antennas in device 10. For example, to support antenna diversity schemes and MIMO schemes or beam forming or other multi-antenna schemes, circuitry 28 may perform signal quality monitoring operations, sensor monitoring operations, and other data gathering operations and may, in response to the gathered data, control which antenna structures within device 10 are being used to receive and process data. As an example, circuitry 28 may control which of two or more antennas is being used to receive incoming radio-frequency signals, may control which of two or more antennas is being used to transmit radio-frequency signals, may control the process of routing incoming data streams over two or more antennas in device 10 in parallel, etc.

Device 10 may also include input-output (I/O) circuitry 30. Circuitry 30 may be used to allow data to be supplied to device 10 and to allow data to be provided from device 10 to external devices. Input-output circuitry 30 may include input-output devices 32 and wireless communications circuitry 34 (as an example). Input-output devices 32 may include touch screens, buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 32 and may receive status information and other output from device 10 using the output resources of input-output devices 32.

Wireless communications circuitry 34 may include radio-frequency (RF) transceiver circuitry formed from one or more integrated circuits (e.g., cellular transceiver circuitry, wireless local area network transceiver circuitry, satellite navigation system receiver circuitry, etc.), power amplifier circuitry, low-noise input amplifiers, passive RF components, one or more antennas, and other circuitry for handling RF wireless signals.

Wireless communications circuitry 34 may include circuitry for other short-range and long-range wireless links if desired. For example, wireless communications circuitry 34 may include wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

DUT 10 may be tested in a test system such as test system 11 shown in FIG. 1. Test system 11 may include test accessories, computers, network equipment, tester control boxes, cabling, test cells, and other test equipment for conveying radio-frequency test signals and gathering test results. Test system 11 may include multiple test stations such as test stations 50. There may, for example, be 80 test stations 50 at a given test site. In general, test system 11 may include any desired number of test stations to achieve desired test throughput.

Each test station 50 may have test equipment 51 that includes a test host (e.g., a personal computer), a test unit (e.g., a vector network analyzer, spectrum analyzer or other types of power meters/signal generators), and a test cell (e.g., a transverse electromagnetic cell or other types of test box operable to shield DUT 10 from unwanted environmental interference and noise). During test operations, test signals may be conveyed between DUT 10 and test equipment 51 via a wireless path or a wired path (see, e.g., path 56). As an example, DUT 10 may be placed in a test box and may communicate with an associated test unit via a test cable that is physically coupled to DUT 10. As another example, DUT 10 may be placed a test box and may communicate with an associated test unit via a radio-frequency coupler (e.g., a near-field test antenna) that is placed in the vicinity of but not in contact with DUT 10.

Test equipment 51 may be controlled automatically by test software 52 running on the test host or may be manually controlled by a test operator. Test software 52 may, for example, generate commands directing the test unit to generate and/or receive test signals to and from DUT 10 and to perform desired measurement on the received test signals. For example, consider a scenario in which test software 52 configures the test unit to generate radio-frequency test signals. The radio-frequency test signals may be radiated wirelessly to DUT 10 using a wireless test probe. DUT 10 may receive at least a portion of the radio-frequency test signals and may respond by transmitting corresponding test signals. The test unit may receive the corresponding test signals via the wireless test probe and perform desired measurements (e.g., measure receive power level, signal-to-noise ratio, power spectral density, frequency response, S-parameter measurements, etc.). This example is merely illustrative and does not serve to limit the scope of the present invention. If desired, each test station 50 may be used to test a different functionality for DUT 10 (e.g., to test wireless communications performance, audio performance, touch-screen sensitivity, display quality, etc.).

Additional test software such as a data collection client 54 may also be implemented on the test host. Data collection client 54 may serve to retrieve control information such as a test station configuration file 58 and other data from a central network server 60 over path 62. The test station configuration file 58 may contain information that is particular to a test station and that specifies certain criteria and guidelines that should be followed when testing each device under test using that test station. Data collection client 58 running in each test station 50 may continuously obtain the most up-to-date test station configuration files 58 from network server 60 to ensure that testing is synchronized across the different test stations (e.g., each test station 50 may dynamically obtain updated test settings from a central server). Network server 60 may, in general, be coupled to at least a portion or all of the test stations at each test site.

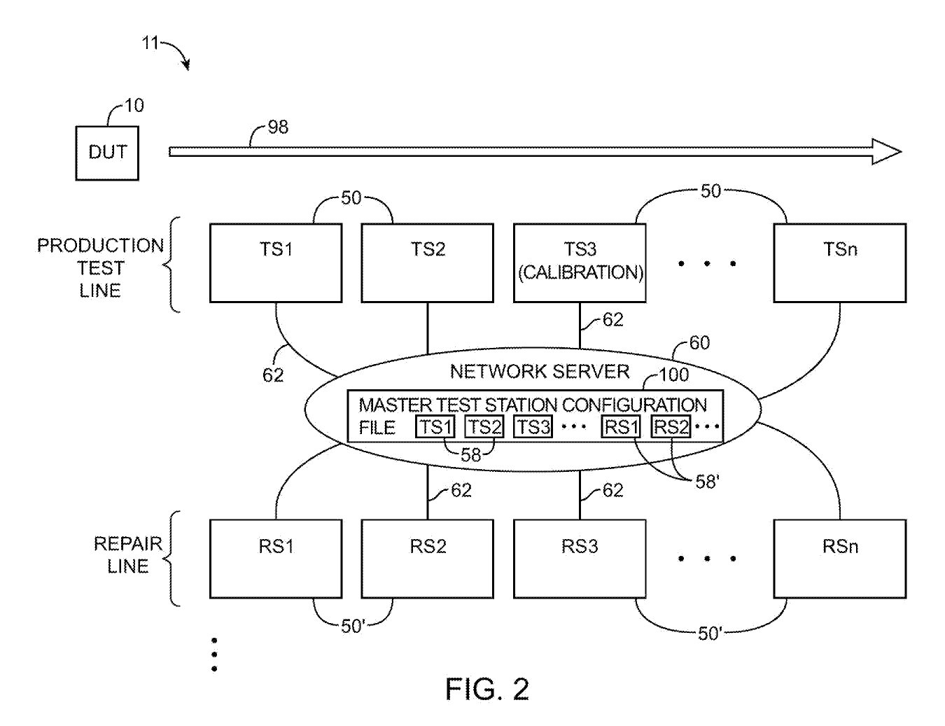

FIG. 2 shows how the different test stations may be arranged. As shown in FIG. 2, a first portion of the stations in test system 11 may serve as production line test stations 50, whereas a second portion of the stations in test system 11 may serve as repair line test stations 50′. Test stations 50 may therefore sometimes be referred to collectively as a production test line, whereas repair stations 50′ may sometimes be referred to collectively as a repair line. There may be multiple repair lines each of which can be used to fix a particular defect on DUT 10 and each having a different number of repair stations 50′ (e.g., different test stations may have different associated repair lines that are used to repair different issues detected using the respective test stations). For example, a first repair line may be used to fix DUTs with faulty speakers, a second repair line may be used to fix DUTs with faulty antennas, a third repair line may be used to fix DUTs with faulty cable connections, etc.

The production test line and the repair line may each include a series of test stations through which DUT 10 has to undergo testing. The test line may include a first test station TS1, a second test station TS2, a third test station TS3, . . . , and n^{th} test station TSn. The test stations may be grouped according to the type of test that is being performed. For example, a first group of test stations (e.g., TS1-TS2) may be used to test the cellular transceiver performance of DUT 10, a second group of test stations (e.g., TS3-TS6) may be used to test the WLAN transceiver performance of DUT 10, a third group of test stations (e.g., TS7-TS11) may be used to test the functionality of I/O devices 32 such as speakers, microphones, touch-screen, buttons, key pads, vibrators, camera, sensors, and/or other user interface devices on DUT 10, etc.

At least one of the test stations may serve as a calibration test station that calibrates DUT 10 (e.g., that prepares DUT 10 for testing in subsequent test stations immediately following that calibration test station). DUT 10 may need to be recalibrated if it fails at one of the subsequent tests that immediately follow that calibration procedure. For example, consider a scenario in which DUT 10 is calibrated using TS3, passes testing at TS4, but fails at TS5. DUT 10 may be sent to a corresponding repair line for rework. After DUT 10 has been repaired, DUT 10 may need to be recalibrated using TS3 before being tested again by TS4 and TS5. Recalibrating DUT 10 in this way ensures that changes made at the repair line are taken into account during testing.

In general, DUT 10 may be tested in a predetermined order. In the example of FIG. 2, DUT 10 may initially be tested using station TS1, may then be tested using TS2, may then be tested using TS3, and so on in that order, as indicated by arrow 98. The test results obtained using each test station 50 may be recorded internally on storage circuitry 28 of DUT 10. For example, a test station may write a passing status into a corresponding entry in a test status table stored on DUT 10 if current test results are satisfactory. If the current test results do not meet design criteria, the test station may instead write a failed status into the corresponding entry in the test status table. Storing information reflective of the pass/falling status associated with each respective test station on DUT 10 prevents the need to query test results from network server 60.

DUT 10 may emerge as a satisfactory device if it successfully passes each of the tests performed in the production test line. The passing device may then be packaged as a brand new product and shipped to end users.

At least some test stations 50 may be configured to check the pass/fail status associated with selected previous stations (e.g., a portion of test stations that precede a “current” test station in the production test line at which DUT 10 is currently located) before testing DUT 10. Test stations in the test line through which DUT 10 has undergone testing prior to arriving at the current test station may generally be referred to as “previous” or preceding test stations. For example, a sixth test station TS6 in the production test line may be configured to check that the test statuses associated with test stations TS3, TS4, and TS5 are each marked as passed (e.g., by checking corresponding entries in the test status table stored on DUT 10). If this condition is met, test station TS6 may proceed to test DUT 10. If this condition is not met, DUT 10 may be sent to a corresponding repair line or a more appropriate test station (e.g., the test station at which DUT 10 has previously failed).

A repair line may include a series of repair test stations 50′ such as first repair station RS1, second repair station RS2, third repair station RS3, . . . , and n^{th} repair station RSn. DUT 10 may be repaired in a predetermined order. In the example of FIG. 2, DUT 10 may initially be repaired using station RS1, RS2, RS3, and so on in that order. After DUT 10 has been passed through the repair line, DUT 10 may be sent to an appropriate test station in the production test line to continue testing.

Test stations 50 that are configured to check test statuses associated with previous test stations for a given DUT may sometimes be referred to as gate keepers. In one suitable embodiment of the present invention, each test station 50 in the production test line may serve as a gate keeper so that a faulty DUT is removed from the production test line as soon as a fault is detected, thereby improving utilization and efficiency of the limited test resources. If desired, at least some of repair station 50′ in the different repair lines may serve as gate keepers.

Information indicating which of the previous test stations qualify as required passing test stations (e.g., previous test stations that are required to have a passing status) can be found in test station configuration file 58 associated with the current test station. The test station configuration file 58 associated with each test station 50 may be different. For example, station TS3 may list TS1 and TS2 as required passing test stations, whereas station TS4 may list T2 and TS3 as required passing test stations. In general, the required passing test stations represent at least a subset of the preceding test stations.

Required passing test stations is only one type of information included in test station configuration file 58. Configuration file 58 may include additional information including a list of related test station statuses to clear if the current test passes (i.e., if test results obtained using the current test station is favorable), a list of related test station statuses to clear if the current test fails (i.e., if test results obtained using the current test station is unsatisfactory), a maximum acceptable fail count for the current station, etc. A master copy of test station configuration file 58 associated with each test station 50 and the test station configuration file 58′ associated with each repair station 50′ may be stored on network server 60 (e.g., master test station configuration file 100 containing files 58 and 58′ may be stored at a central server).

For example, a first master copy of file 58 associated with TS1, a second master copy of file 58 associated with TS2, a third master copy of file 58 associated with TS3, . . . , an n^{th} master copy of file 58 associated with TSn, a first master copy of file 58′ associated with RS1, a second master copy of file 58′ associated with RS2, . . . , and an n^{th} master copy of file 58′ associated with RSn may be stored on network server 60. Each test station may constantly update in real time its local existing file 58 by replacing its existing file 58 that is stored locally on that test station by the master copy maintained on network server 60. Configured in this way, a master test operator may make changes to the master test station configuration file 100, and the changes will be propagated to the corresponding test stations.

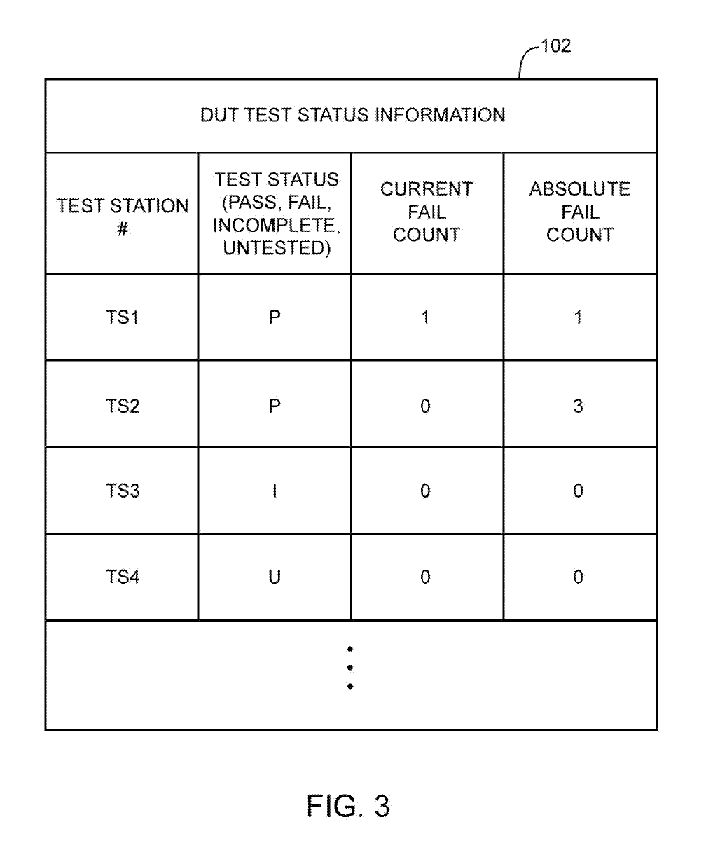

As described in connection with FIG. 2, test data gathered from the different test stations may be stored internally on storage and processing circuitry 28 of DUT 10. FIG. 3 shows illustrative test status information that may be stored on each DUT. As shown in FIG. 3, the test status information may be organized in a table 102 (as an example).

The test status information may, in general, be arranged and stored in a list or any suitable data structure. Table 102 may, for example, include information such as a test status, current fail count, absolute fail count, and other test-related information for each test station in test system 11.

A test status entry may indicate either pass (P), fail (F), incomplete (I), or untested (U) for a corresponding test station. In the example of FIG. 3, this particular DUT has successfully passed testing at TS1 and TS2 and is currently being tested at TS3 (e.g., a test station may change the DUT's test status from untested to incomplete when it receives DUT 10 from a preceding station before performing any tests of its own). The test status for TS4 and other subsequent test stations may be set to its default value of U.

A current fail count entry in table 102 may indicate the number of times that DUT 10 has failed since it was last repaired in an associated repair line. The current fail count for the current test station may be reset to zero if DUT 10 repeatedly fails at the current test station and has to be sent to the associated repair line for rework. The current fail count may therefore sometimes be referred to as a relative fail count (e.g., a value counting the number of times DUT 10 has failed since it was last repaired).

Table 102 may also keep track of the absolute fail count (e.g., the total number of times DUT 10 has ever failed at each test station). The absolute fail count can be incremented in response to DUT 10 failing at a particular test station. The absolute fail count (sometimes referred to as total or cumulative fail count) may not be reset to zero even if DUT 10 has been sent to a repair line. The absolute fail count may therefore be at least equal to or greater than the current fail count for each test station.

In the example of FIG. 3, this particular DUT has only failed once at TS1 (i.e., current fail count is equal to absolute fail count) but passed on its second iteration, has failed for a total of three times at TS2 but passed on the first iteration after being repaired by repair stations associated with TS2 (i.e., test status is set to P and current fail zero has been reset to zero), and has just begun testing at TS3 (i.e., test status is set to I with neither passing nor failing results yet). In this example, if DUT 10 passes on the first iteration, the corresponding test status for TS3 will be set to P (without changing the current and absolute fail count). If DUT 10 fails on the first iteration, the test status for TS3 will be set to F and the current fail count and the absolute fail count will each be incremented by one.

DUT test status information of the type described in connection with FIG. 3 is merely illustrative and does not serve to limit the scope of the present invention. In general, table 102 stored in each DUT 10 is different depending on the type of defects that are present in each DUT 10. If desired, table 102 may also have entries that record test status and fail count for not only test stations 50 in the production test line but also repair stations 50′ in the repair line.

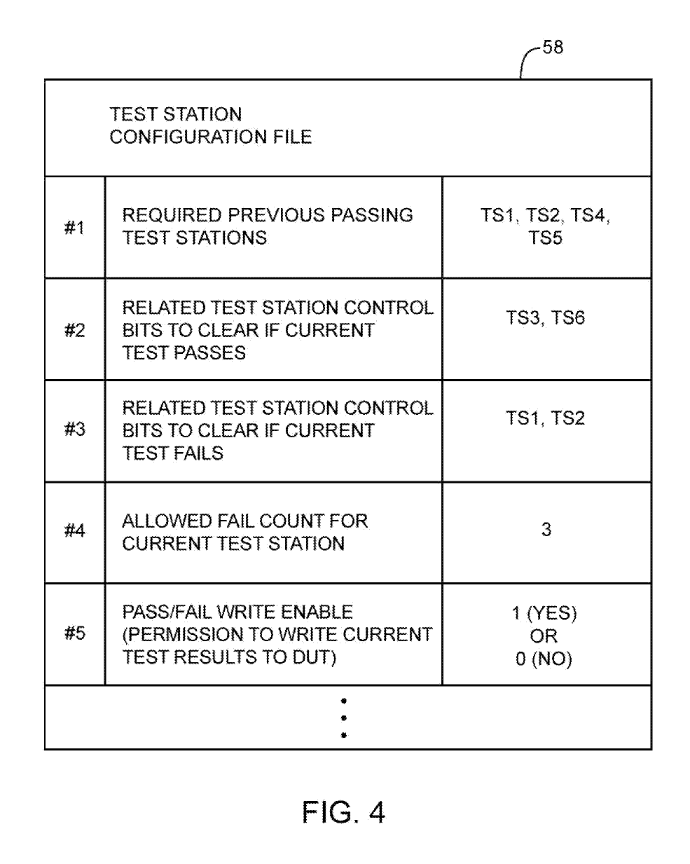

FIG. 4 is a diagram of an exemplary test station configuration file 58 that can be stored at each test station (or repair station). As described in connection with FIG. 2, file 58 may include a first entry (#1) specifying a list of required previous passing test stations. For example, consider a scenario in which test station TS7 is the current test station and receives updated test station configuration file 58 as shown in FIG. 4. Entry #1 may specify TS1, TS2, TS4, and TS5 as required previous passing test stations. Test station TS7 may therefore scan the corresponding test status entries for TS1, TS2, TS4 and TS5 in table 102 stored on DUT 10 to check if the test statuses for each of those test stations are marked as P (passing). If at least one of the test status entries associated with the required passing test stations is showing a failed status, TS7 may display an alert to the test operator so that the test operator will send DUT 10 to the repair line or a more appropriate test station for testing (e.g., DUT 10 will not be tested using TS7 if the criteria specified in entry #1 is not met). If all of the test status entries associated with the required passing test stations have a passing status, TS7 may then proceed to test DUT 10.

File 58 may also include a second entry (#2) specifying a list of related test station test statuses to clear if the test being performed by the current test station passes. In the scenario described above (i.e., assuming the current test station is TS7), entry #2 may specify that test status information 102 associated with TS3 and TS6 for that DUT be cleared upon passing at TS7 (e.g., the test status and current failed count entries associated with those test stations be set to untested and zero, respectively). In general, the related test stations may include any subset of preceding (previous) test stations, subsequent test stations (i.e., test stations further down in the production test line), and any associated repair stations. As an example, a calibration test station may include a list of test stations that immediately follow the current test station in its entry #2, because recalibration will invalidate any existing tests that have been performed by those associated test stations.

File 58 may also include a third entry (#3) specifying a list of related test station test statuses to clear if the test being performed by the current test station fails. In the scenario described above (i.e., assuming the current test station is TS7), entry #3 may specify that test status information 102 associated with TS1 and TS2 for that DUT be cleared upon passing at TS7 (e.g., the test status and current failed count entries associated with those test stations be set to untested and zero, respectively). The test stations specified in entries #2 and #3 may be mutually exclusive (e.g., a test station listed in entry #2 typically will not be listed in entry #3). In general, the related test stations may include any subset of preceding (previous) test stations, subsequent test stations (i.e., test stations further down in the production test line), and any associated repair stations. As an example, a current test station may include an associated calibration test station in its entry #3, because a failed test at the current test station could potentially invalidate any previously performed calibration.

File 58 may include a fourth entry (#4) specifying the maximum allowed fail count for the current test station. During testing, DUT 10 can be tested multiple times (e.g., DUT 10 may be retested upon failing) before being sent to a repair line. The test station may check the current (relative) fail count stored on DUT 10 against the allowed fail count specified by criteria #4 to determine whether to send that DUT to the repair line. In the scenario described above, the maximum allowed fail count for TS7 may be equal to three. If the corresponding current fail count for TS7 stored on DUT 10 is less than or equal to three, TS7 may repeat its test for DUT 10 (e.g., DUT 10 can be tested again using the current test station if the current fail count does not exceed the maximum allowed fail count specified by criteria #4). If the corresponding current fail count for TS7 stored on DUT 10 is greater than three, TS7 may display an alert to the test operator so that the test operator sends DUT 10 to the repair line (e.g., DUT 10 is not allowed to be tested again using the current test station if the current fail count exceeds the maximum allowed fail count specified by criteria #4).

File 58 may also include a fifth entry (#5) that specifies whether the current test station has permission to write its results to DUT 10. For example, entry #5 may either have a pass/fail write enable value of one or zero. If the write enable value of the current test station is one, the current test station will be able to write its test result to DUT 10 (e.g., the current test station can change the DUT test status to one of P, F, I, or U). If the write enable value of the current test station is zero, the current test station does not have permission to alter the test status of DUT 10. As an example, test stations may have a pass/fail write enable value of one, whereas repair stations may have a pass/fail write enable value of zero.

In general, the stations specified in entries #2 and #3 in test station configuration file 58 can still be cleared even if the does not have pass/fail write permission (e.g., the pass/fail write enable value may only affect the current station's ability to change the test status of DUT 10).

Configuration file 58 of FIG. 4 is merely illustrative and does not serve to limit the scope of the present invention. If desired, configuration file 58 may include other suitable information for configuring each station in the production test line and the repair line.

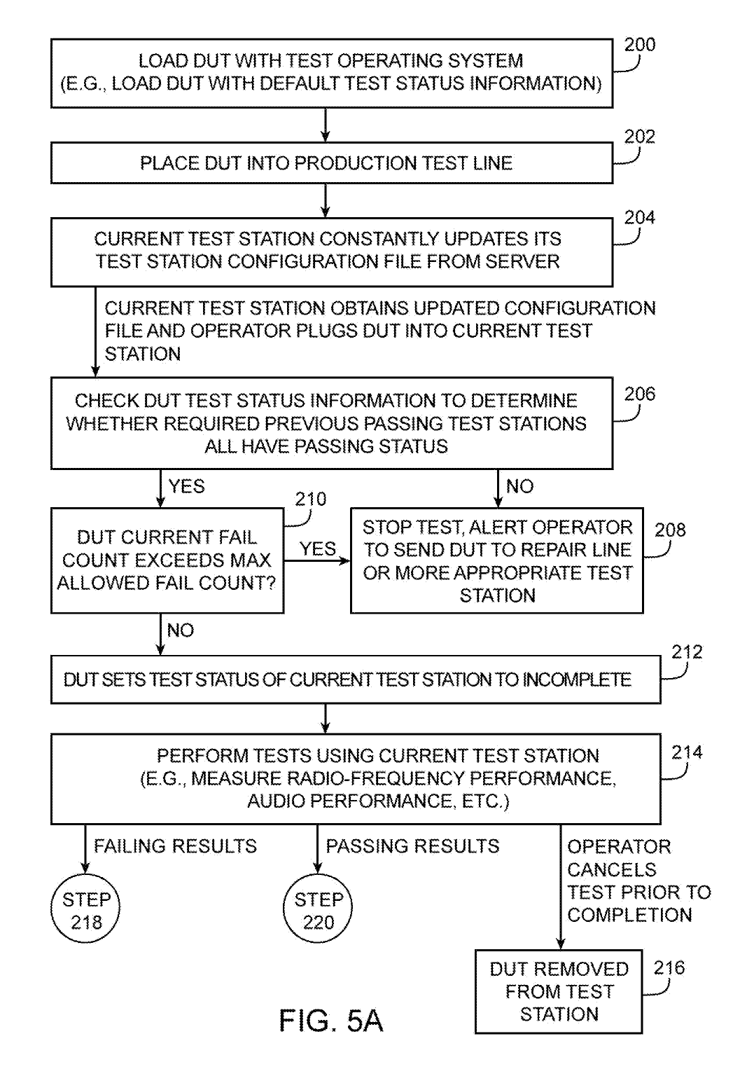

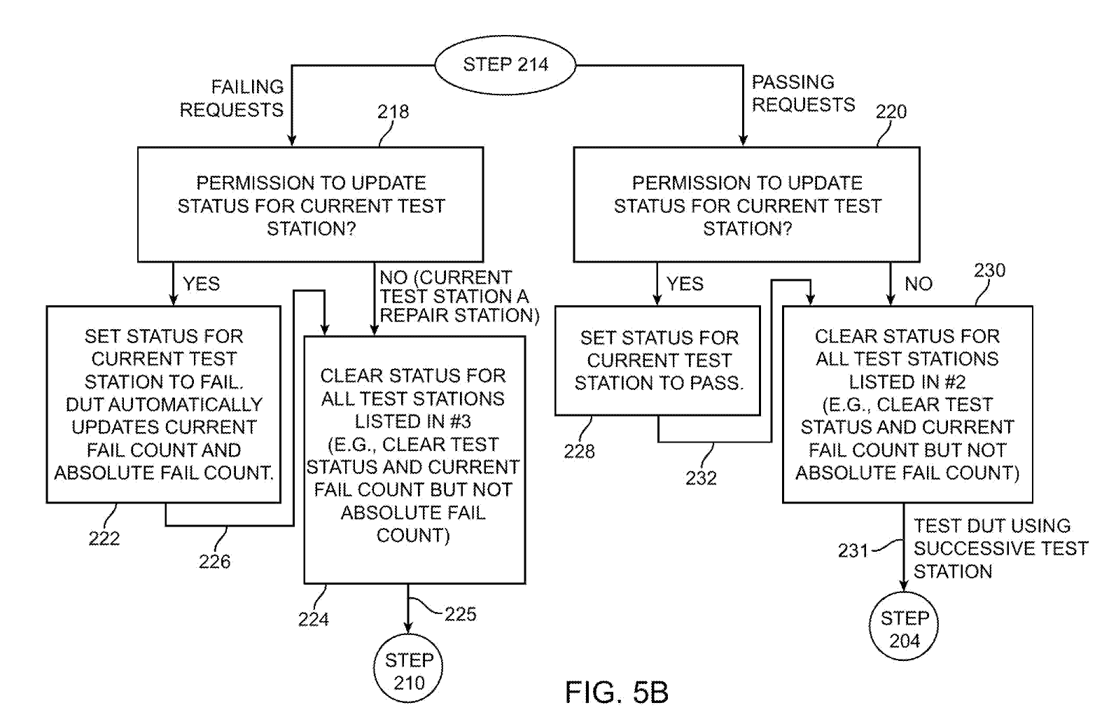

FIGS. 5A and 5B show illustrative steps involved in operating test system 11. At step 200, DUT 10 may be configured with a test operating system (e.g., DUT 10 may be loaded with default test status information). The default test status information may have an untested test status, a current fail count of zero, and an absolute fail count of zero for each test station in table 102 that is stored on storage circuitry 28 of DUT 10.

At step 202, DUT 10 may be placed into the production test line. Each test station in the production test line may be constantly updating its test station configuration file 58 by synchronizing its local file 58 with the master copy stored on network server 60 (step 204). The test station at which DUT 10 is currently being tested may be referred to as a current test station. A test operator may connect DUT 10 to the current test station (e.g., by plugging DUT 10 into a test unit in the current test station). After DUT 10 has been plugged in to the current test station, the current test station may check DUT test status information 102 to determine whether the required passing test stations all have passing status (step 206).

In response to determining that at least one of the required previous passing test stations has a failing status, the current test station may display an alert to the test operator so that the test operator can send DUT 10 to the repair line or more appropriate station (step 208). In response to determining that all of the required previous passing test stations have a passing status, the current test station may compare the DUT's current fail count with the maximum allowed fail count for that test station (e.g., step 210, by comparing the current fail count in table 102 to entry #4 in configuration file 58). If the DUT's current fail count exceeds the maximum allowed fail count, testing may be interrupted (step 208). If the DUT's current fail count is less than or equal to the maximum allowed fail count, testing may proceed to step 212.

At step 212, DUT 10 may set its test status for the current test station to incomplete (I) to indicate that testing using the current test station has been initiated. At step 214, the current test station may perform the desired tests on DUT 10 (e.g., the test station may be configured to measure radio-frequency performance, audio/display performance, touch-screen sensitivity, etc.). If the test operator decides to cancel the current tests, DUT 10 may be removed from the current test station (step 216).

If test results obtained using the current test station is unsatisfactory, processing may proceed to step 218. At step 218, the current test station may check whether it has permission to update the test status for DUT (i.e., by checking entry #5 in its configuration file 58). In response to determining that the test status write enable value is zero (no permission), the test status and current fail count for the related test stations listed in entry #3 of file 58 may be reset to untested (U) and zero, respectively (step 224). The absolute fail count may not be cleared to zero. Repair stations 50′ may often transition from step 218 directly to step 224 without performing step 222. In response to determining that the test status write enable value is one (permission granted), the test status associated with the current test station may be set to fail and the current fail count and absolute fail count may each be incremented by one (step 226). Step 224 may then be performed, as indicated by path 226. Processing may then loop back to step 210 for additional testing, as indicated by path 225.

If test results obtained using the current test station satisfies design criteria, processing may proceed to step 220. At step 220, the current test station may check whether it has permission to update the test status for DUT (i.e., by checking entry #5 in its configuration file 58). In response to determining that the test status write enable value is zero (no permission), the test status and current fail count for the related test stations listed in entry #2 of file 58 may be reset to untested (U) and zero, respectively (step 230). The absolute fail count may not be cleared to zero. In response to determining that the test status write enable value is one (permission granted), the test status associated with the current test station may be set to pass (step 228). Step 230 may then be performed, as indicated by path 232. DUT 10 may then be tested using a successive test station immediately following the current test station in the production test line (e.g., processing may loop back to step 204 to test DUT 10 using a new test station), as indicated by path 231.

The foregoing is merely illustrative of the principles of this invention and various modifications can be made by those skilled in the art without departing from the scope and spirit of the invention. The foregoing embodiments may be implemented individually or in any combination.

What is claimed is:

1. A method for testing a device under test comprising:
with a current test station, determining whether the device under test has successfully passed testing at a previous test station through which the device under test has previously undergone testing before arriving at the current test station; and
in response to determining that the device under test has successfully passed testing at the previous test station, performing testing on the device under test using the current test station.

2. The method defined in claim 1 wherein determining whether the device under test has successfully passed testing at the previous test station comprises analyzing test status information stored on the device under test.

3. The method defined in claim 2 further comprising:
determining whether the device under test has successfully passed testing at the current test station.

4. The method defined in claim 3 further comprising:
in response to determining that the device under test has successfully passed testing at the current test station, changing a test status associated with the current test station to a passing test status by updating the test status information stored on the device under test.

5. The method defined in claim 3 further comprising:
in response to determining that the device under test has failed testing at the current test station, changing a test status associated with the current test station to a failing test status by updating the test status information stored on the device under test.

6. The method defined in claim 5 further comprising:
in response to determining that the device under test has failed testing at the current test station, incrementing a fail count associated with the current test station by updating the test status information stored on the device under test.

7. The method defined in claim 5 further comprising:
in response to determining that the device under test has failed testing at the current test station, sending the device under test to a repair station for rework.

8. A method for testing a device under test using a plurality of test stations, the method comprising:
loading the device under test with test status information for each of the test stations, wherein the test status information indicates whether the device under test has been tested at each of the test stations and whether the device under test has successfully passed testing at each of the test stations;
testing the device under test with a test station in the plurality of test stations; and
in response to obtaining test results from testing the device under test using the test station, updating the test status information on the device under test.

9. The method defined in claim 8 further comprising:
loading the test station with a test station configuration file retrieved from a network server that is coupled to the plurality of test stations.

10. The method defined in claim 9 wherein the test station configuration file includes a list of required previous passing test stations, and wherein testing the device under test with the test station comprises:
determining whether the device under test has successfully passed testing at the required previous passing test stations; and
in response to determining that the device under test has successfully passed testing at the required previous passing test stations, testing the device under test with the test station.

11. The method defined in claim 9 wherein the test station configuration file includes a first list of related test stations, the method further comprising:
determining whether the device under test has successfully passed testing at the test station; and
in response to determining that the device under test has successfully passed testing at the test station, changing a test status associated with each of the test stations in the first list of related test stations by updating the test status information stored on the device under test.

12. The method defined in claim 11 wherein the test station configuration file includes a second list of related test stations, the method further comprising:
in response to determining that the device under test has failed testing at the test station, changing the test status associated with each of the test stations in the second list of related test stations by updating the test status information stored on the device under test.

13. The method defined in claim 11 wherein updating the test status information on the device under test comprises:
in response to determining that the device under test has failed testing at the test station, incrementing a fail count for the test station.

14. The method defined in claim 13 wherein the test station configuration file specifies a predetermined fail count threshold, the method further comprising:
in response to determining that the fail count for the test station exceeds the predetermined failed count threshold, removing the device under test from the test station.

15. The method defined in claim 9 wherein the test station configuration file includes a write enable value that specifies whether the test station has permission to update a test status for the test station.

16. A test system comprising:
a network server; and
a plurality of test stations that are coupled to the network server, wherein at least one of the test stations is loaded with a test station configuration file and is configured to update its test station configuration file by retrieving data from the network server, and wherein the at least one test station is configured to perform testing on a device under test based on information in the test station configuration file.

17. The test system defined in claim 16, wherein a first portion of the test stations is configured to determine whether the device under test satisfies design criteria, and wherein a second portion of the test stations is configured to repair defects present in the device under test.

18. The test system defined in claim 17, wherein the first portion of test stations includes at least one calibration test station configured to calibrate the device under test for testing.

19. The test system defined in claim 16, wherein the at least one test station includes a test unit for testing the device under test and a test host for controlling the test unit, and wherein the test host is operable to store test results in the device under test.

20. The test system defined in claim, wherein the at least one test station further includes a test cell in which the device under test is tested, and wherein the test cell is configured to reduce noise generated from test stations other than the at least one test station in the plurality of test stations.
